(19) United States
(12) Patent Application Publication
(10) Pub. No.: US 2019/0277352 A1
(43) Pub. Date: Sep. 12, 2019

(54) CENTRIFUGAL CLUTCH HAVING TWO SERIES-CONNECTED CLUTCH ELEMENTS

(71) Applicant: Schaeffler Technologies AG & Co. KG, Herzogenaurach (DE)

(72) Inventor: Sebastian Heuberger, Buhl (DE)

(73) Assignee: Schaeffler Technologies AG & Co. KG, Herzogenaurach (DE)

(21) Appl. No.: 16/332,517

(22) PCT Filed: Nov. 14, 2017
(86) PCT No.: PCT/DE2017/100960

§ 371 Date: Mar. 12, 2019

(30) Foreign Application Priority Data
Nov. 29, 2016 (DE) 10 2016 223 606.7

(51) Int. Cl. F16D 43/30; F16D 43/18; F16D 13/18

(52) U.S. Cl. CPC F16D 43/30; F16D 13/18; F16D 43/18

(57) ABSTRACT

A centrifugal clutch (1) is provided for a drive train of a motor vehicle, having a motor-driven torque input component (2) and a downstream first clutch element (3) which has at least one first centrifugal mass (4) which can be displaced radially to transmit torque in order to move into a non-positive connection with a transmission-side torque output component (5) when in the displaced state. A second clutch element (6) having a second centrifugal mass (7), which can be displaced radially into a non-positive connection with an intermediate component (8) when in the displaced state to transmit torque, is connected in series with the first clutch element in the torque path.

### BACKGROUND

The invention relates to a centrifugal clutch for a drive train of a motor vehicle, for example, a motorcycle, with a motor-drivable/driven torque input component/torque inlet component and a downstream first clutch element that has at least one first centrifugal mass that can be displaced in the radial direction for transmitting torque, in order to move, in the displaced state, into a non-positive connection with a transmission-side torque output component.

From the prior art, centrifugal clutches are already known. Among other things, DE 20 2007 008 855 U1 discloses a centrifugal clutch, especially for model vehicles, which contains a cylindrical clutch drum and a clutch hub supported in this drum so that it can rotate, wherein, on the periphery of the clutch hub there are at least two clutch jaws that are constructed as centrifugal weights and can be moved in the radial direction up to planar contact on the inner lateral surface of the clutch drum relative to a spring force and have, at least on the contact surface, a friction lining, characterized in that at least the friction lining of the clutch jaws is made from a light metal material or from brass.

The prior art, however, has always had the disadvantage that centrifugal clutches are constructed, in order to provide a correspondingly high starting torque, so that they close first in a correspondingly high rotational speed range and thus cannot transmit a torque at low rotational speeds.

### SUMMARY

The objective of the invention, therefore, is to avoid or at least reduce the disadvantages from the prior art and to develop a centrifugal clutch that is very compact and can be used over a wide rotational speed range.

This objective is met in a device according to the class according to the invention in that a second clutch element with a second centrifugal mass, which can be displaced in the radial direction for transmitting torque, in order to move, in the displaced state, into the non-positive connection with an intermediate component, is connected in series with the first clutch element in the path of torque forces.

This has the advantage that such a centrifugal clutch has a very simple construction and a torque can be transmitted over the entire rotational speed range. Also, at low rotational speeds, which, however, are above the starting rotational speed, the centrifugal clutch transfers the torque of the motor, because the clutch remains actuated by the second clutch element that couples as a function of the rotational speed of the transmission-side torque output component. Nevertheless, the clutch can be simultaneously set so that the clutch closes, for a stopped motor vehicle, only in a comparatively high rotational speed range, in order to provide a corresponding starting torque.

Advantageous embodiments are provided in the claims and will be explained in more detail below.

Thus, it is preferable if the intermediate component and/or the torque output component have/has an angular sheet and/or pot-shaped construction. Thus, the intermediate component and the torque output component can advantageously surround the centrifugal masses radially from the outside, so that they can be moved in contact with the centrifugal masses for a displacement of the centrifugal masses due to the centrifugal forces and a torque is transmitted.

It is further advantageous if multiple first centrifugal masses are locked in rotation with the intermediate component, which advantageously produces a larger non-positive connection between the first centrifugal masses and the torque output component, and thus a larger torque can be transmitted.

It is also advantageous if multiple second centrifugal masses are locked in rotation with the torque output component, because in this way the non-positive connection between the intermediate component and the second centrifugal masses is increased by the multiple contacting surfaces.

In addition, the first centrifugal masses and/or the second centrifugal masses can be arranged equally distributed across the periphery, because then a uniform non-positive connection viewed across the periphery is generated between the respective non-positive connection partners/friction partners, which effectively prevents slippage of the clutch.

Preferably, three first centrifugal masses and/or three second centrifugal masses are present. In particular, for three centrifugal masses distributed across the periphery, an especially good torque transfer is possible in which impacts by the imbalance of the centrifugal masses is avoided.

In addition, the first centrifugal masses in a preferred embodiment are different in terms of geometry and/or weight relative to the second centrifugal masses. Thus, the clutch can be used in a larger rotational speed range. Then it provides a high starting torque, because the centrifugal clutch in a stopped vehicle is engaged only at a relatively high rotational speed, but simultaneously it can also transfer a torque for decreasing rotational speeds of the motor vehicle, because the smaller centrifugal masses of the second clutch element connected in series also transfer torque at a low rotational speed.

In addition, it is preferable if the first centrifugal masses can be moved into a non-positive connection, in particular, a friction fit, with an inner-side contact surface of the torque output component. In this way, depending on the rotational speed, the clutch can be closed, and a torque can be transmitted from the torque input component that is locked in rotation with the motor to the torque output component that is locked in rotation with the transmission.

It is also advantageous if the second centrifugal masses can be moved into a non-positive connection, especially a friction fit, with an inner-side contact surface of the intermediate component. Especially for a decrease of the rotational speed in a driving motor vehicle, the torque is transmitted from the second clutch element to the intermediate component that is connected, in turn, to the torque input component.

A favorable embodiment is distinguished in that the intermediate component forms an engagement through and within the first centrifugal masses and can be moved into a non-positive connection with the second centrifugal masses outside of the second centrifugal masses on its contact surface. This is especially advantageous because due to the intermeshing of the two clutch elements, the clutch elements can be actuated independently from each other and nevertheless only a very low installation space is needed for the centrifugal clutch that can transfer a transmission-side and also a motor-side torque.

It is further advantageous if the torque output component forms an engagement through and within the second centrifugal masses and can be moved into a non-positive connection outside of the first centrifugal masses on its contact surface with the second centrifugal masses. For the intermeshing of the clutch elements, it is also advantageously possible that the torque output component forms an engagement through the elements and thus enables the independent actuation of both clutch elements without restricting the other clutch element in its function.

Preferably, part of the torque output component can form an engagement over and outside of the second clutch element and/or the intermediate component and are moved into a non-positive connection on its contact surface with the first centrifugal masses. Thus, the torque output component encloses the second clutch element, but is first actuated by the first centrifugal masses, which produces a very high structural compactness.

In addition, in a preferred embodiment, a part of the intermediate component can form an engagement over and outside of the first clutch element and/or the torque output component and can be moved into a non-positive connection on its contact surface with the second centrifugal masses. According to the requirement, it is exactly possible to construct the intermediate component on the outside, without the function of one of the two clutch elements being negatively influenced.

Preferably, the first and/or the second centrifugal masses are supported so that they can rotate. Because the centrifugal masses have asymmetric constructions, a part of the centrifugal masses is displaced radially outward for a rotation caused by the centrifugal force about the fixed axis of rotation, which advantageously leads to a non-positive-connection transfer of torque between the centrifugal masses and their associated friction partners.

The first and/or second centrifugal masses can each be supported on a pin. The support by a pin offers the great advantage that the centrifugal masses can be attached easily. The pin is preferably held on both ends by the intermediate component or the torque output component, so that the centrifugal masses are attached in an advantageously especially secure and rotationally locked manner.

It is further useful if an outer surface of the first centrifugal masses is matched geometrically and/or in terms of material to the contact surface of the torque output component, so that advantageously the friction between the first centrifugal masses and the torque output component is as high as possible.

It is also advantageous if the outer surface of the first centrifugal masses forms a flush contact on the contact surface of the torque output component, which generates an especially large non-positive connection between the first centrifugal masses and the torque output component.

Furthermore, the contact between the outer surface of the first centrifugal masses and the contact surface of the torque output component preferably has a large surface construction. The larger the contact surfaces are, the better the non-positive connection between the friction partners and the larger the torque that can be transferred, without causing slippage of the torque output component.

A favorable embodiment is distinguished in that an outer surface of the second centrifugal masses is matched in terms of geometry and/or material to the contact surface of the intermediate component. Thus, advantageously the friction between the second centrifugal masses and the intermediate component can be influenced selectively so that it is as high as possible.

In addition, the outer surface of the second centrifugal masses in a preferred embodiment can form a flush contact on the contact surface of the intermediate component, which advantageously promotes the non-positive connection between the displaced second centrifugal masses and the intermediate component.

In addition, it is advantageous if the contact between the outer surface of the second centrifugal masses and the contact surface of the torque output component has a large surface construction, because a larger contacting surface results in a higher friction contact/non-positive connection.

Preferably, there is a clutch in the damper, so that impacts of the motor are effectively damped and the centrifugal clutch is not damaged.

The damper can be arranged before the first clutch element and/or between the first and the second clutch element and/or after the second clutch element, which is associated with structural advantages according to the structural construction of the centrifugal clutch.

Preferably, the damper is constructed as a rubber damper/plastic damper, because the oscillations/imbalance can be damped in an especially effective way by the elastic material.

It is also advantageous if the torque output component has central inner teeth that are constructed to couple the torque output component locked in rotation with an externally toothed shaft. Through the positive connection and central attachment of a transmission-fixed shaft on the torque output component, the torque of the motor is transferred to the transmission in a relatively loss-free way.

In other words, the invention relates to a centrifugal clutch that consists of two conventional centrifugal clutches and thus can transfer a torque across the entire rotational speed range. In addition, there is a motor controller, so that the gear can be changed. The motor controller makes it possible, when the shift lever is actuated, to shift up or down across, e.g., an engine misfire, without requiring the opening of the clutch. Due to the in-line shifting of the two clutch elements, it is also possible to start both without actuating the clutch and also to shift without actuating the clutch.

### BRIEF DESCRIPTION OF THE DRAWINGS

The invention will be explained below with the help of a drawing. Shown are:

FIG. 1 a longitudinal section through a centrifugal clutch according to the invention according to a first embodiment,

FIG. 2 a schematic diagram of the centrifugal clutch according to FIG. 1,

FIGS. 3 to 6 a perspective view of a first clutch element of the centrifugal clutch in different stages of assembly,

FIGS. 7 to 8 a perspective view of a second clutch element of the centrifugal clutch in different stages of the assembly, and

FIG. 9 a perspective view of the centrifugal clutch in assembled state.

### DETAILED DESCRIPTION

The figures are only of a schematic nature and are used only for understanding the invention. Identical elements are provided with the same reference symbols.

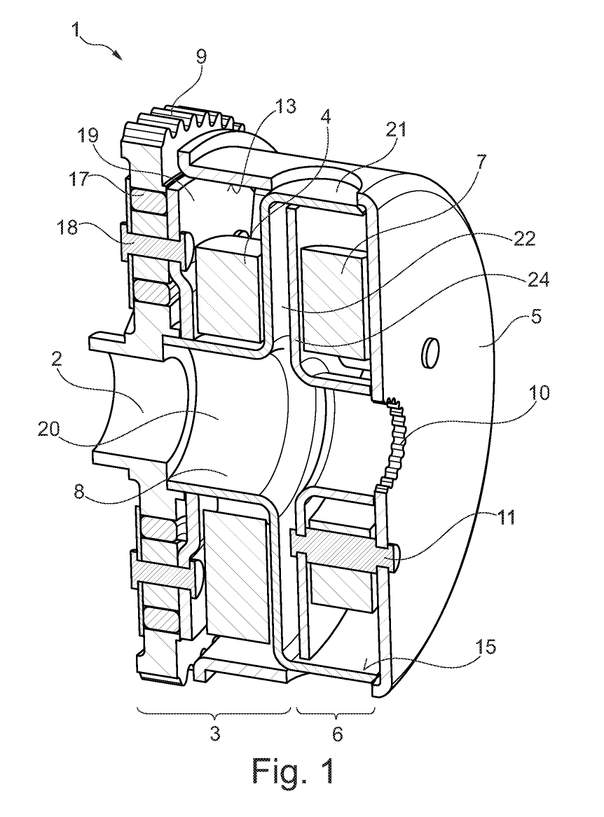

In FIG. 1, a centrifugal clutch 1 is shown. The centrifugal clutch 1 has a motor drivable torque input component 2 and a downstream first clutch element 3 with three first centrifugal masses 4. The first centrifugal masses 4 can be displaced in the radial direction, in order to transfer, in the displaced state, a motor-side torque in a non-positive connection to a transmission-side torque output component 5. A second clutch element 6 is connected in series to the first clutch element 3. The second clutch element 6 has three second centrifugal masses 7 that can be displaced in the radial direction, in order to transfer, in the displaced state, a transmission-side torque in a non-positive connection to an intermediate component 8.

The first clutch element 3 and the second clutch element 6 can be actuated independent from each other and transfer a torque between a motor and a transmission in a non-positive connection. The torque input component 2, also called primary gear, is locked in rotation by means of external teeth 9 to the motor and turns as a function of the motor rotational speed. The intermediate component 8, on which the first centrifugal weights 4 are supported, is mounted on the torque input component 2. The intermediate component 8 has an angular sheet form and is used as a non-positive connection partner for the second centrifugal masses 7 that are supported on the torque output component 5. The torque output component 5 has centrally arranged internal teeth 10 that are designed to couple the torque output component 5 with a transmission input shaft in a rotationally locked manner.

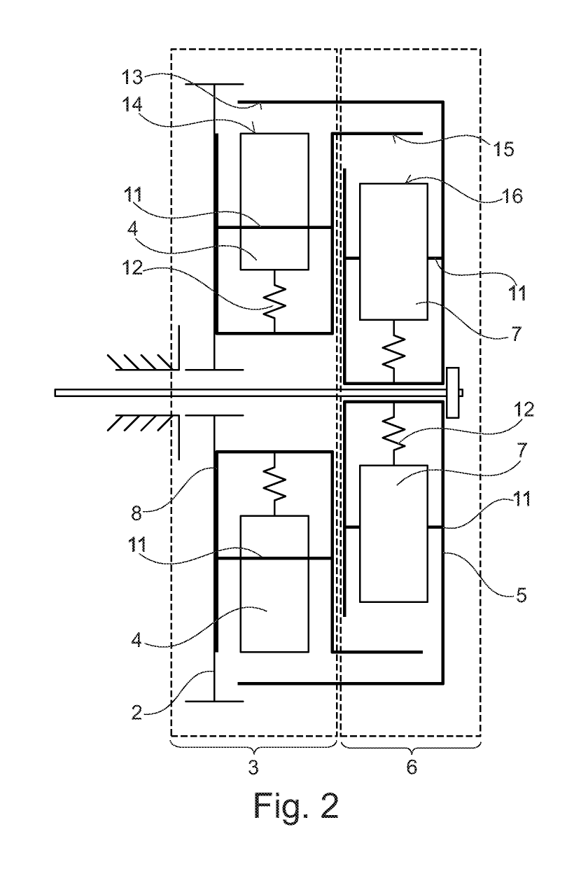

FIG. 2 shows a schematic diagram of the centrifugal coupling 1. The first centrifugal masses 4 and the second centrifugal masses 7 are supported on a pin 11 on the intermediate component 8 or on the torque output component 5. The first centrifugal masses 4 and the second centrifugal masses 7, however, can rotate about the axis of the pin 11. The rotational movement about the pin axis results, due to the geometric asymmetric construction of the centrifugal masses 4, 7 in a radial displacement of a part of the first and second centrifugal masses 4, 7. This radial displacement acts against a spring 12, because the centrifugal masses 4, 7 must overcome a spring force.

When the torque input component 2 rotates, the first centrifugal masses 4 are set into rotation by means of the intermediate component 8. Due to the centrifugal force, the first centrifugal masses 4 are pressed radially outward, which is allowed by the rotation about the axis of the pin 11. The first centrifugal masses 4 are displaced until they contact an inner side contact surface 13 of the torque output component 5. Because the contact surface 13 is matched to the geometry of the first centrifugal masses 4, an outer surface 14 of the first centrifugal masses 4 forms a flush contact with the largest possible surface on the contact surface 13.

The second clutch element 6 is equally actuated. For a rotation of the torque output component 2, for example, by the rotation of the transmission of a driving vehicle, the second centrifugal masses 7 are set into rotation. Due to the centrifugal force, the second centrifugal masses 7 are pressed radially outward, which is possible by the rotation about the respective axis of the pin 11. The second centrifugal masses 7 are displaced radially until they contact an inner-side contact surface 15 of the intermediate component 8. Again, the geometry of the contact surface 15 is matched to an outer surface 16 of the second centrifugal masses that contact the contact surface 15.

The first centrifugal masses 4 preferably have a geometrically different construction relative to the second centrifugal masses 7 so that they close the first clutch element 3 only at a higher rotational speed.

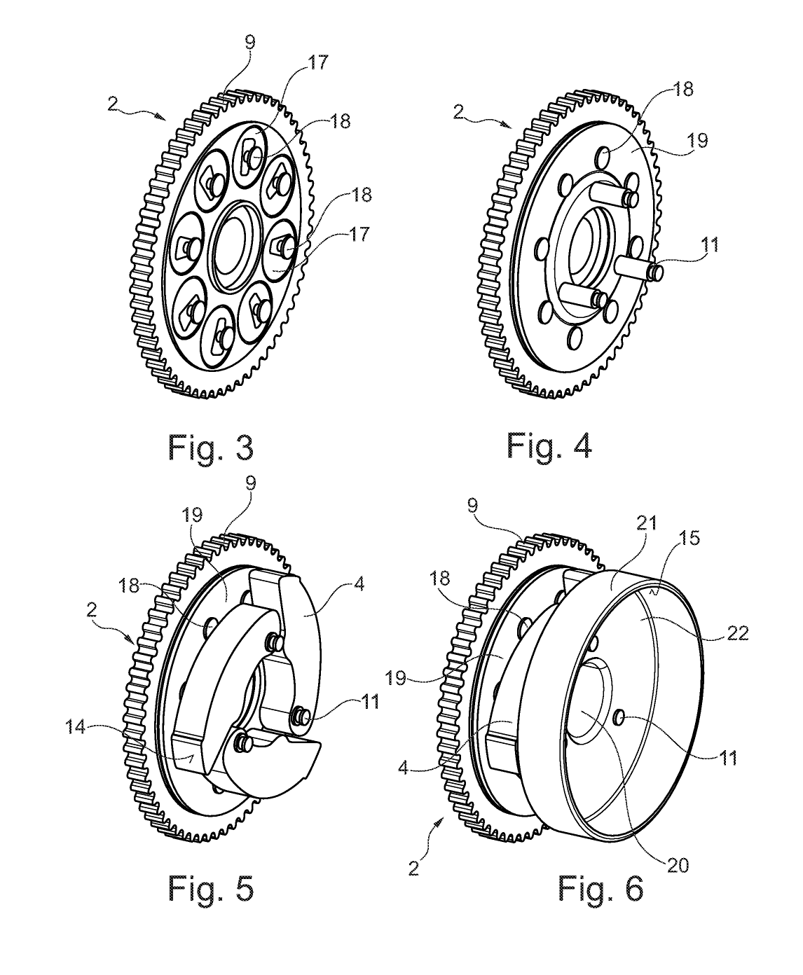

FIGS. 3 to 6 show different stages of the assembly of the first clutch element 3. In FIG. 3, the torque input component 2 is shown. The torque input component 2 is constructed as a gearwheel with external teeth 9 and can be locked in rotation with the motor. In the torque input component 2 there is a damper 17 that damps the oscillations. The damper 17 has 8 damper components that are distributed equally across the periphery each in a recess of the torque input component 2. The damper 17 is made from circular plastic/rubber plates. The damper components are each fastened to the torque input component 2 by a bolt 18.

FIG. 4 shows the torque input component 2, on which a plate 19 is fastened by the bolt 18, wherein, in the plate 19, the three pins 11 are integrated, which hold the first centrifugal masses 4. The plate 19 is part of the intermediate component 8 and can be constructed separately as in this embodiment or also integrally with the intermediate component 8. The plate 19 forms a flush contact on the torque input component 2 and is locked in rotation with it.

In FIG. 5, the first centrifugal masses 4 are fastened to the pins 11. There are three first centrifugal masses 4 that are arranged distributed uniformly across the periphery. The first centrifugal masses 4 can be pivoted by the centrifugal force about the pin 11, so that part of the first centrifugal masses 4 are displaced radially outward.

In FIG. 6, the intermediate component 8 is mounted on the torque input component 2. The intermediate component 8 has two cylindrical areas 20, 21 that are connected by a plate-shaped area 22. The first cylindrical area 20 has a diameter that is dimensioned so that it can form an engagement through and within the first centrifugal masses 4 and is fastened on the torque input component 2. By the plate area 22 that is arranged parallel to the plate 19 and holds the pins 11 on one end, the intermediate component 8 transitions into the second cylindrical area that has a diameter such that the second cylindrical area 21 radially surrounds the second centrifugal masses 7 and can be contacted on its inner contact surface 15 by the second centrifugal masses 7. The plate 19 is also part of the intermediate component 8, because it holds the pins 11 on the other end.

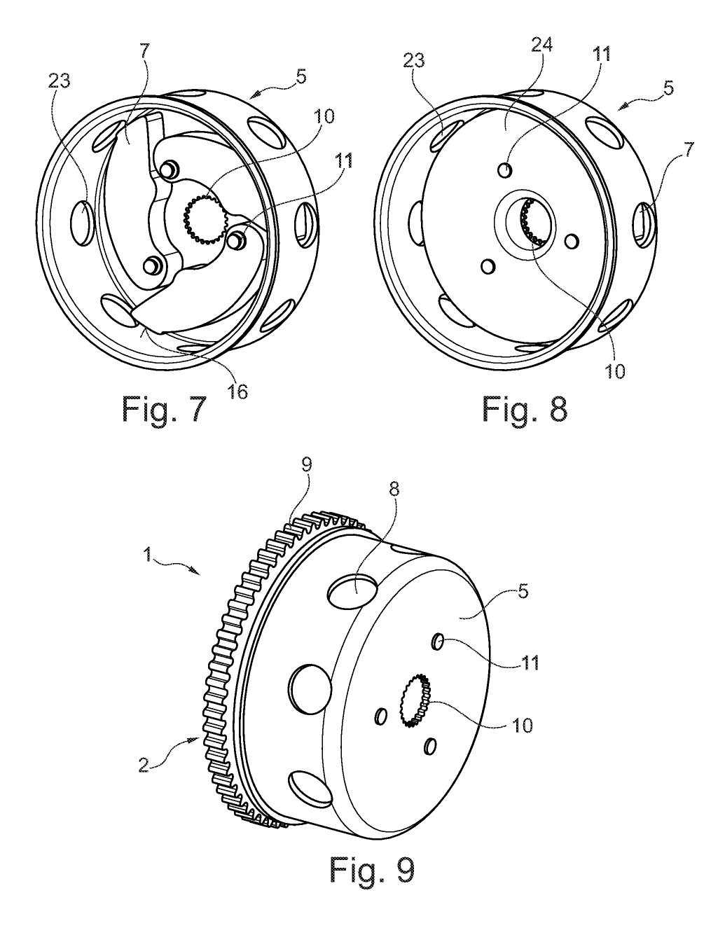

FIGS. 7 and 8 show the second clutch element 6. In FIG. 7, the pot-shaped torque output component 5 is shown, which holds, by three pins 11, the three uniformly distributed, second centrifugal masses 7. The outer diameter of the part of the torque output component 5 extending in the peripheral direction is dimensioned so that it forms an engagement over the second centrifugal masses 7 and also over the intermediate component 8 on the outside, so that it can be moved into a non-positive connection on its contact surface 13 in the first clutch element 3 with the first centrifugal masses 4. Distributed across the periphery, there are 8 circular recesses 23 that provide weight savings and can be used for lubricating the components. The torque output component 5 is locked in rotation on the transmission by the internal teeth 10.

In FIG. 8, an insert 24, which is part of the torque output component 5, is inserted, which holds the pins 11 and forms a boundary to the first clutch element 3. The insert 24 can be constructed separately or integrally with the torque output component 5.

In FIG. 9, the centrifugal clutch 1 is shown in an assembled state. Here, the torque output component 5 surrounds the intermediate component 8 and the first and second centrifugal masses 4, 7 on the outside in the radial direction. The centrifugal clutch 1 has a very compact construction and provides a positive connection option for the motor and the transmission by the internal teeth 10 on the torque output component 5 and the external teeth 9 on the torque input component 2.

### LIST OF REFERENCE SYMBOLS

1 Centrifugal clutch
2 Torque input component
3 First clutch element
4 First centrifugal mass
5 Torque output component
6 Second clutch element
7 Second centrifugal mass
8 Intermediate component
9 External teeth
10 Internal teeth
11 Pin
12 Spring
13 Contact surface of the torque output component
14 Outer surface of the first centrifugal masses
15 Contact surface of the intermediate component
16 Outer surface of the second centrifugal masses
17 Damper
18 Bolt
19 Plate
20 First cylinder area
21 Second cylinder area
22 Plate area
23 Opening
24 Insert

1. A centrifugal clutch for a drive train of a motor vehicle, comprising:
a motor drivable torque input component;
a transmission-side torque output component;
a downstream first clutch element that has at least one first centrifugal mass that is displaceable in a radial direction for transmitting torque, in order to move into a non-positive connection with the transmission-side torque output component in a displaced state;
an intermediate component; and
a second clutch element connected in series with the first clutch element in a path of the torque forces, the second clutch element includes at least one second centrifugal mass, which is displaceable in the radial direction for transmitting the torque, in order to move, in a displaced state, into a non-positive connection with the intermediate component.

2. The centrifugal clutch according to claim 1, wherein at least one of the intermediate component or the torque output component has at least one of an angular sheet-shaped or pot-shaped construction.

3. The centrifugal clutch according to claim 1, wherein the at least one first centrifugal mass comprises multiple first centrifugal masses locked in rotation with the intermediate component.

4. The centrifugal clutch according to claim 1, wherein the at least one second centrifugal mass comprises multiple second centrifugal masses locked in rotation with the torque output component.

5. The centrifugal clutch according to claim 4, wherein the at least one first centrifugal mass has at least one of a different geometry or weight relative to the at least one second centrifugal mass.

6. The centrifugal clutch according to claim 3, wherein the first centrifugal masses are movable into a non-positive connection with an inner-side contact surface of the torque output component.

7. The centrifugal clutch according to claim 4, wherein the second centrifugal masses are movable into a non-positive connection with an inner-side contact surface of the intermediate component.

8. The centrifugal clutch according to claim 7, wherein the intermediate component forms an engagement through and within the first centrifugal masses and is movable into a non-positive connection with the second centrifugal masses outside of the second centrifugal masses on a contact surface thereof.

9. The centrifugal clutch according to claim 8, wherein a part of the torque output component forms an engagement over and outside at least one of the second clutch element or the intermediate component and is movable into a non-positive connection with the first centrifugal masses on its contact surface.

10. The centrifugal clutch according to claim 3, wherein the first centrifugal masses are rotatably supported.

11. The centrifugal clutch according to claim 4, wherein the second centrifugal masses are rotatably supported.

12. A centrifugal clutch for a drive train of a motor vehicle, comprising:
a motor drivable torque input component;
a transmission-side torque output component;
an intermediate component;
a first clutch element that has at least one first centrifugal mass rotatably connected to the motor drivable torque input component and the intermediate component, the at least one first centrifugal mass is displaceable in a radial direction into a non-positive connection with the transmission-side torque output component for transmitting torque in a displaced state; and
a second clutch element that has at least one second centrifugal mass rotatably connected to the transmission-side torque output component, the at least one second centrifugal mass is displaceable in the radial direction into a non-positive connection with the intermediate component for transmitting the torque in a displaced state.

13. The centrifugal clutch according to claim 12, wherein the at least one first centrifugal mass comprises a plurality of first centrifugal masses, each rotatably connected to the motor drivable torque input component and the intermediate component.

14. The centrifugal clutch according to claim 13, wherein the at least one second centrifugal mass comprises a plurality of second centrifugal masses, each rotatably connected to the transmission-side torque output component.

15. The centrifugal clutch according to claim 14, wherein the first centrifugal masses have at least one of a different geometry or weight relative to the second centrifugal masses.

16. The centrifugal clutch according to claim 14, wherein the intermediate component is formed from sheet metal and includes a Z-shaped cross-sectional profile.

17. The centrifugal clutch according to claim 16, wherein the transmission-side torque output component is cup-shaped, and includes a plurality of circumferentially spaced-apart openings in a radially outer wall in an axial position of a radially outer flange of the Z-shaped cross-sectional profile of the intermediate component.

18. The centrifugal clutch according to claim 12, further comprising an insert, and the at least one second centrifugal mass is mounted via a pin between the transmission-side torque output component and the insert.
